(19) United States
(12) Patent Application Publication
(10) Pub. No.: US 2012/0195032 A1
(43) Pub. Date: Aug. 2, 2012

(54) MODULAR LIGHTING ASSEMBLY

(76) Inventor: Larry N. Shew, Highland, MI (US)

(21) Appl. No.: 13/442,843

(22) Filed: Apr. 9, 2012

Related U.S. Application Data
(63) Continuation-in-part of application No. 12/983,227, filed on Dec. 31, 2010.
Application No. 12/983,227 is a continuation-in-part of application No. 13/417,169, filed on Mar. 9, 2012.
(60) Provisional application No. 61/473,769, filed on Apr. 9, 2011.
(60) Provisional application No. 61/335,132, filed on Dec. 31, 2009.
(60) Provisional application No. 61/450,825, filed on Mar. 9, 2011.

(51) Int. Cl. F21L 4/00; F21V 7/00; F21S 9/00

(52) U.S. Cl. 362/183; 362/457; 362/257; 362/157

(57) ABSTRACT

The present invention includes an LED lighting fixture containing: a housing insert electronically communicating with the light fixture; and one or more LED modules electronically communicating with the housing insert upon receipt of direct current power from the housing insert. One or more LED modules are removably seated within the housing insert for ready replacement of the LED modules while conserving unnecessary waste by preserving the continued use of the housing insert.

### CROSS REFERENCE TO RELATED APPLICATIONS

This application claims the benefit of U.S. Provisional Application Ser. No. 61/473,769 filed on Apr. 9, 2011. This application also claims the benefit of and is a continuation-in-part of co-pending U.S. application Ser. No. 12/983,227 having a filing date of Dec. 31, 2010 (which claims the benefit of U.S. Provisional Application No. 61/335,132 filed on Dec. 31, 2009). This application also claims the benefit of and is a continuation-in-part of co-pending U.S. application Ser. No. 13/417,169 having a filing date of Mar. 9, 2012 (which claims the benefit of U.S. Provisional Application No. 61/450,825 filed on Mar. 9, 2011).

### BACKGROUND OF THE INVENTION

The present invention relates to light assemblies that incorporate a night-light and/or an emergency light within an LED (light emitting diode) light assembly. Alternatively, the novel LED light assembly of the present invention may be designed into a single light source having a multi-functional light. During the day, the LED light assembly will function as the primary light source, operating all the LEDs within the light assembly. During the night, the LED light assembly will function as a night light, operating only a limited number of LEDs to avoid complete darkness within the space and during a power loss, operating the same number of LEDs to again avoid darkness. The inventor contemplates that these concerns may most efficiently be managed during the construction of a new home or new commercial building.

Presently, there are various conventional light fixtures that incorporate emergency lighting, and are powered by AC energy with battery backup. When the power is unexpectedly interrupted due to a storm or other event, the emergency lighting automatically illuminates. Cost is one issue related to most of these conventional emergency lighting systems as they are very expensive.

Yet another issue for a conventional stand-alone emergency lighting system that may contain incandescent, fluorescent or halogen lamp and may be powered by expensive, alkaline, sealed lead battery modules is the relatively short charge time. Many of these conventional systems are generally only designed to provide at a maximum between one to three hours of effective emergency lighting. Not only is this approach expensive, this presents a concern for emergency generated power outages that last longer than three hours.

Yet another issue is that current design trends favor the spatial and aesthetic benefits typically provided by fluorescent tubes, even though fluorescent tubes cost more to operate than LED assemblies.

Yet another concern is the cost of illuminating conventional lighting such as incandescent, fluorescent, or halogenated light sources.

Fixtures using fluorescent tubes or LED light assemblies as its source of lighting are common in homes, offices and retail stores. Fluorescent tubes may typically use 60-80% more energy than LED light tubes. Fluorescent lighting system are not practicable for such emergency lighting due to their high voltage and alternating current requirements making a battery backup difficult during power failure. It is therefore an ongoing effort to improve LED lighting sources to provide adequate lighting for longer periods while reducing the manufacturing and operating costs.

Typical LED light tube assemblies currently on the market operate only as a primary light source for the home and the work place. As a way to provide night lighting within a space, owners typically would leave on several light fixtures during the night. As energy costs continue to grow, owners are looking for other options to reduce energy cost. The present invention would mitigate the need of leaving several light fixtures on during the night, saving energy cost for the owner. The present invention may also provide additional operating time during a power failure, at the same time improving the light quality of the night-light at night.

One concern with the use of LED tubular light bulbs is the heat retention within the lighting assemblies. Heat management is an ongoing challenge to ensure that the LED light assemblies enjoy a reasonable longevity and lifetime of use.

Yet another concern is that the dispersion of the LED light might be effectively accomplished without the use of bulbs, further in keeping with the heat management concern.

It would therefore be an improvement in the art to provide an LED lighting assembly that resolves the aforementioned concerns.

### SUMMARY OF THE INVENTION

The above-referenced concerns are resolved by providing a first embodiment of an LED lighting assembly containing: a housing; one or more solid state lighting units contained within the housing and actuated by alternating current power; a night light contained within the housing and operably communicating with the solid state lighting units, the night light actuated by direct current power in the absence of light from the solid state lighting units; one or more light emitting diodes contained within the night light; and a battery source for powering the night light in the event of power interruption.

A second embodiment of an LED lighting assembly in accordance with the present invention includes a light assembly containing: a housing; one or more solid state lighting units contained within the housing and actuated by alternating current power; a night light contained within the housing and operably communicating with the solid state lighting units, the night light actuated by direct current power in the absence of light from the solid state lighting units; and a direct current power supply contained within the housing and operably communicating with the night light; one or more light emitting diodes contained within the night light and powered by the direct current power supply; a battery source for powering the night light in the event of power interruption; and a battery charger within the housing and actuated by direct current power, the battery charger operably communicating with the battery source.

In yet another aspect of the invention, a lighting unit contains: a housing or elongated tube; one or more light emitting diodes contained within the housing or elongated tube; and a battery source contained within the housing or elongated tube, the battery source configured to selectively power the light emitting diodes with direct current energy.

In yet another aspect of the present invention, a lighting unit contains: a tubeless and bulb-free sub-housing in contrast to and as distinguished by the tubular bulbs typically used in fluorescent tube technology for example; a first array containing one or more light emitting diodes (LEDs) contained within the bulb-free sub-housing that function as a direct current- or DC-powered emergency/night light; a second array containing one or more light emitting diodes contained within the bulb-free housing that function as an alternating current or AC solid state lighting by converting the AC power to DC power for operation of the LEDs; a battery source contained within the housing or elongated tube, the battery source configured to selectively power the first array of LEDs with DC power in the absence of AC power; and a photo-switch/sensor that selectively actuates the first array of LEDs and powers them with AC/DC power in normal operation of the lighting unit.

In yet another aspect of the present invention, a lighting unit or assembly contains: any one of the embodiments of the present invention containing a light deflector or reflector for predetermined distribution of the light penumbras emanating from the light assemblies or modular LED light assemblies of the present invention. The light deflector may or may not be adjustable to tailor the intensity of the light directed below.

In yet another aspect of the present invention, a modular lighting unit is presented that contributes to a reduction in waste caused by disposing of an entire LED bulb or assembly when light emitting diodes therein burn out. The energy benefit of providing LEDs is retained while yet providing a means to replace the LEDs without requiring replacement of the entire lighting assembly. Accordingly, one or more modular LED lighting strips or modules may be provided for easy insertion and extraction from housing inserts containing the same. The housing inserts containing the modular LED light strips are formed to provide ready placement within known troffer light fixtures typically containing fluorescent light tubes.

Stated another way, the present invention includes an LED lighting fixture containing: a housing insert electronically communicating with the light fixture; and one or more LED modules electronically communicating with the housing insert upon receipt of direct current power from the housing insert. One or more LED modules are removably seated within the housing insert for ready replacement of the LED modules while conserving unnecessary waste by preserving the continued use of the housing insert.

### BRIEF DESCRIPTION OF THE DRAWINGS

FIG. 1 illustrates a perspective view of one embodiment of a light assembly in accordance with the present invention.

FIG. 2 illustrates a perspective view of one embodiment of a light assembly in accordance with the present invention.

FIG. 3 illustrates a view of one embodiment of a light assembly within a conventional fluorescent troffer assembly, in accordance with the present invention.

FIG. 4 illustrates a top view of one embodiment of a light assembly in accordance with the present invention.

FIG. 5 illustrates a cross-section view of one embodiment of a light assembly in accordance with the present invention.

FIG. 6 illustrates a view of a circuit board of one embodiment of a light assembly in accordance with the present invention.

FIG. 7 illustrates a perspective view of an end portion of a fluorescent troffer in accordance with the present invention.

FIG. 8 illustrates a perspective view of a second embodiment of a light assembly in accordance with the present invention.

FIG. 9 illustrates a perspective view of a second embodiment showing the connections between the lithium batteries and the light emitting diode(s) in accordance with the present invention.

FIG. 10 is a schematic of the operation of a lighting unit in accordance with the present invention.

FIG. 11 is an embodiment of the present invention incorporating a bulb-free and open housing.

FIG. 12 is another view of the embodiment of FIG. 11.

FIG. 13 is a top view of another embodiment similar to the embodiment of FIG. 11, with fewer LED lights.

FIG. 14 is a side view of the embodiment of FIG. 13, illustrating placement of the batteries.

FIG. 15 is a bottom view of the embodiment of FIG. 13.

FIG. 16 is a perspective view of yet another embodiment illustrating an open and bulb-free sub-housing, the embodiment functioning as a replacement to typical fluorescent tubes.

FIG. 17 is a bottom view of the embodiment of FIG. 13, illustrating the access panel to service the battery source.

FIG. 18 is a view of yet another embodiment similar to the embodiment of FIG. 11, wherein reflective portions are illustrated that direct the radiation of the light.

FIG. 19 is a view of a conventional troffer or housing containing both fluorescent and a light assembly in accordance with the present invention.

FIG. 20 is a view of a light assembly similar to FIG. 11, but having only one end cap for electrical communication with an associated troffer or housing.

FIG. 21 is a view of the light assembly of FIG. 20 illustrating the removable battery compartments.

FIG. 22 illustrates the installation of the light assembly of FIG. 20 within a troffer or housing.

FIG. 23 illustrates a light unit and an LED panel wired in accordance with the present invention, for insertion within a troffer or housing.

FIG. 24 illustrates a side view of the light unit of FIG. 23.

FIG. 25 illustrates a top view of the panel of FIG. 23.

FIG. 26 illustrates a bottom view of the schematic wiring of the panel of FIG. 23.

FIG. 27 illustrates a schematic of the circuitry of the embodiments of FIGS. 11-26.

FIG. 28 illustrates a perspective and schematic view of a replacement light assembly for a fluorescent tube troffer, the assembly containing an AC-DC converter and other desired circuitry within a housing insert for a troffer, and further containing a modular LED insert for insertion within a housing insert.

FIG. 29 illustrates a perspective view of the back side of the embodiment of FIG. 28 wherein a battery source compartment and batteries are schematically illustrated.

FIG. 30 illustrates a perspective view of the embodiment of FIG. 28 illustrating the insertion of the modular LED insert within the housing insert.

FIG. 31 illustrates a perspective view of yet another embodiment showing a plurality of modular LED inserts within a housing insert for a troffer, and may be connected in series with each other and with the end caps of the housing insert.

FIG. 32 illustrates another embodiment of a replacement light assembly for a fluorescent tube troffer, the figure schematically illustrating the assembly containing known LED bulb circuitry and further containing a modular LED insert for insertion within a housing insert.

FIG. 33 illustrates a side view of the embodiment of FIG. 32 wherein the LED insert is placed within the housing insert.

FIG. 34a schematically illustrates one embodiment having a semi-circular modular LED insert for insertion into a housing insert.

FIG. 34b illustrates the embodiment of FIG. 34a having the LED insert fixed within the housing insert.

FIG. 34c schematically illustrates an embodiment similar to that of FIG. 34a containing a battery source and a removable access panel for access to the battery source.

FIG. 34d schematically illustrates one embodiment having a semi-circular modular LED insert for insertion into a housing insert, the embodiment further containing a light deflector extending from the housing insert.

FIG. 34e schematically illustrates the embodiment of FIG. 34d having the LED insert fixed within the housing insert.

FIG. 34f schematically illustrates an embodiment similar to that of FIG. 34d containing a battery source and a removable access panel for access to the battery source.

FIG. 34g schematically illustrates one embodiment having a bulb-less modular LED insert for insertion into a housing insert, the embodiment further containing a light deflector extending from the housing insert.

FIG. 34h schematically illustrates the embodiment of FIG. 34g having the bulb-less LED insert fixed within the housing insert.

FIG. 34i schematically illustrates an embodiment similar to that of FIG. 34g containing a battery source and a removable access panel for access to the battery source.

FIG. 35 schematically illustrates placement of one or more of housing inserts of FIGS. 34a through 34c within a troffer light fixture designed for fluorescent tubes.

FIG. 36 schematically illustrates a side view of the fluorescent tube troffer of FIG. 35.

FIG. 37 schematically illustrates placement of one or more of housing inserts of FIGS. 34g through 34i within a troffer light fixture designed for fluorescent tubes.

FIG. 38 schematically illustrates a side view of the fluorescent tube troffer of FIG. 37.

FIG. 39a schematically illustrates one embodiment with a rectangular cross-section, the light assembly containing a first exemplary angular position of a light deflector with one type of bulb-less LED insert.

FIG. 39b schematically illustrates yet another embodiment with a rectangular cross-section, the light assembly containing a second exemplary angular position of a light deflector with yet another type of bulb-less LED insert, and a battery source and an access panel.

FIG. 39c schematically illustrates the embodiment of FIG. 39a showing the removability of the LED insert.

FIG. 39d schematically illustrates yet another embodiment with a rectangular cross-section, the light assembly containing a third exemplary angular position of a light deflector having a curved reflective surface, with one type of bulb-less LED insert.

FIG. 40 schematically illustrates a side view of a housing insert containing known LED circuitry used within a troffer light fixture for fluorescent tubes, and further illustrates a modular LED insert for placement within the housing insert.

FIG. 41 schematically illustrates a top view of the housing insert or socket of the embodiment of FIG. 40.

FIG. 42 illustrates a top view of the modular LED light strip of FIG. 40.

FIGS. 43a through 43c illustrates an exemplary variety of plugs or prongs contained in the modular LED light strips of the present invention.

FIG. 44 illustrates yet another flow chart exemplifying one electronic configuration for providing power to light assemblies of the present invention, those in FIGS. 28 through 40, for example.

FIG. 45 illustrates yet another flow chart exemplifying yet another electronic configuration for providing normal power and emergency power, and night light sensing, to modular LED light strip assemblies as described in FIGS. 28 through 40 for example.

### DETAILED DESCRIPTION OF THE PREFERRED EMBODIMENT(S)

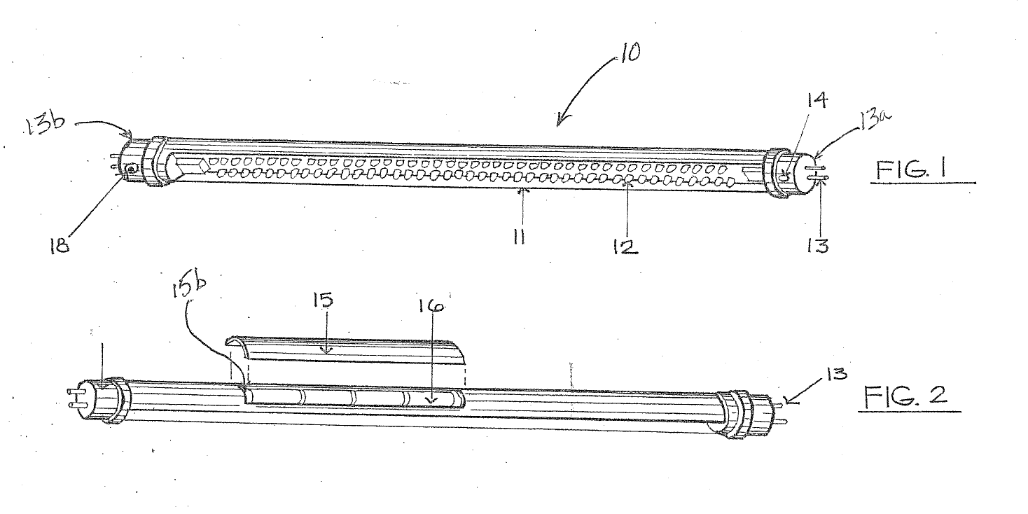

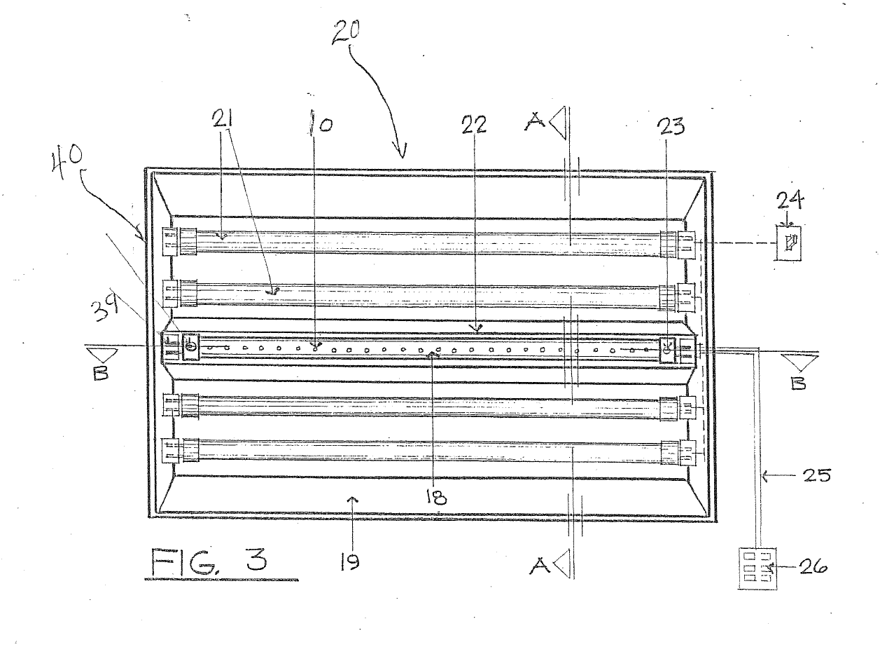

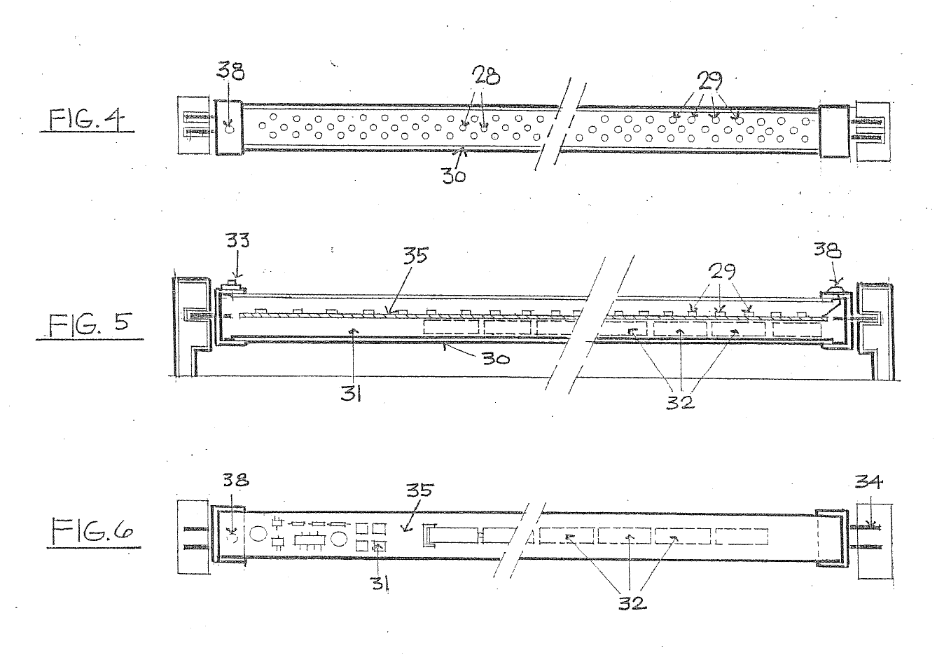

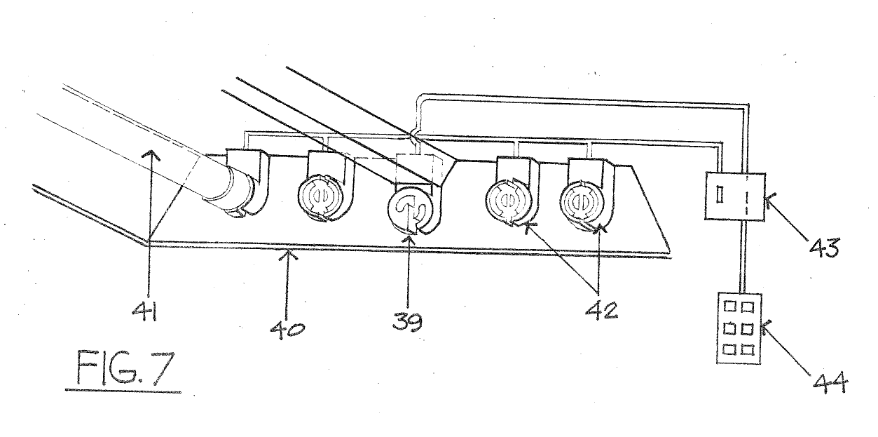

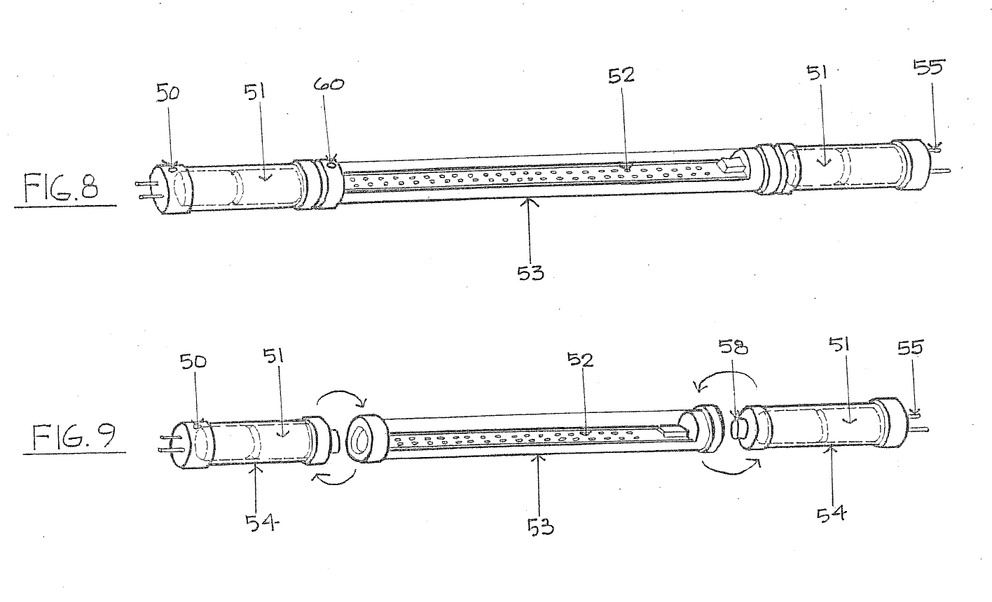

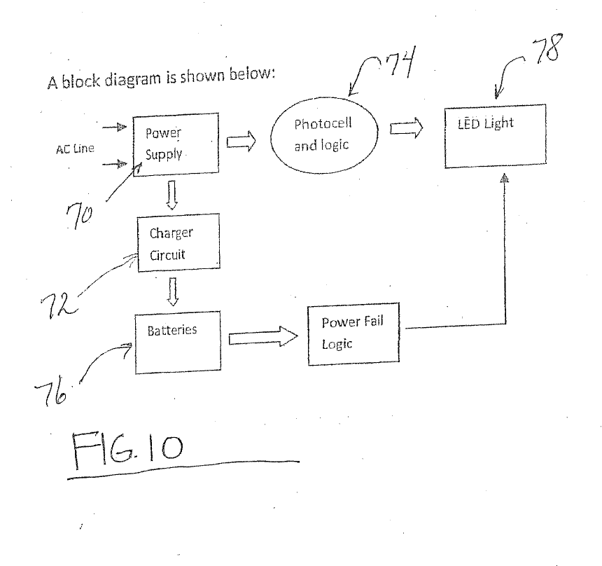

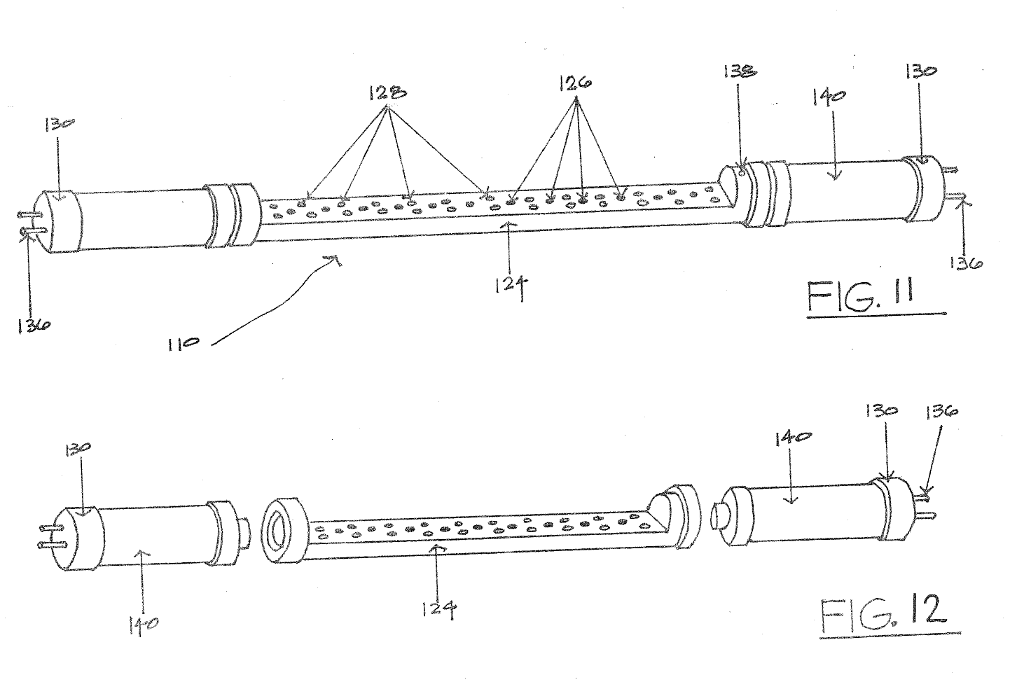

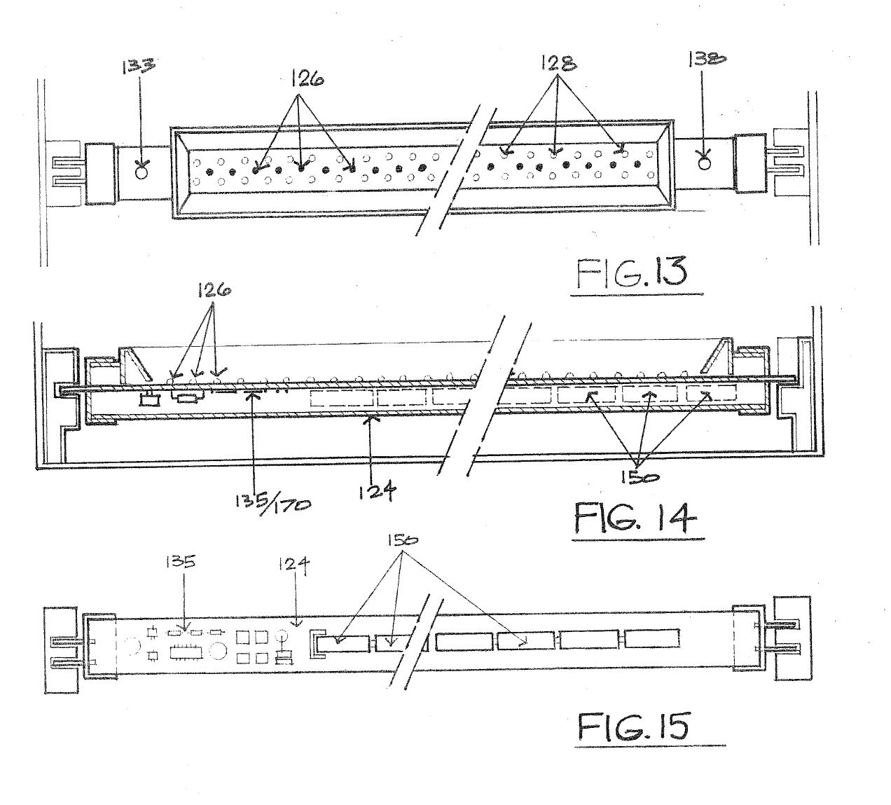

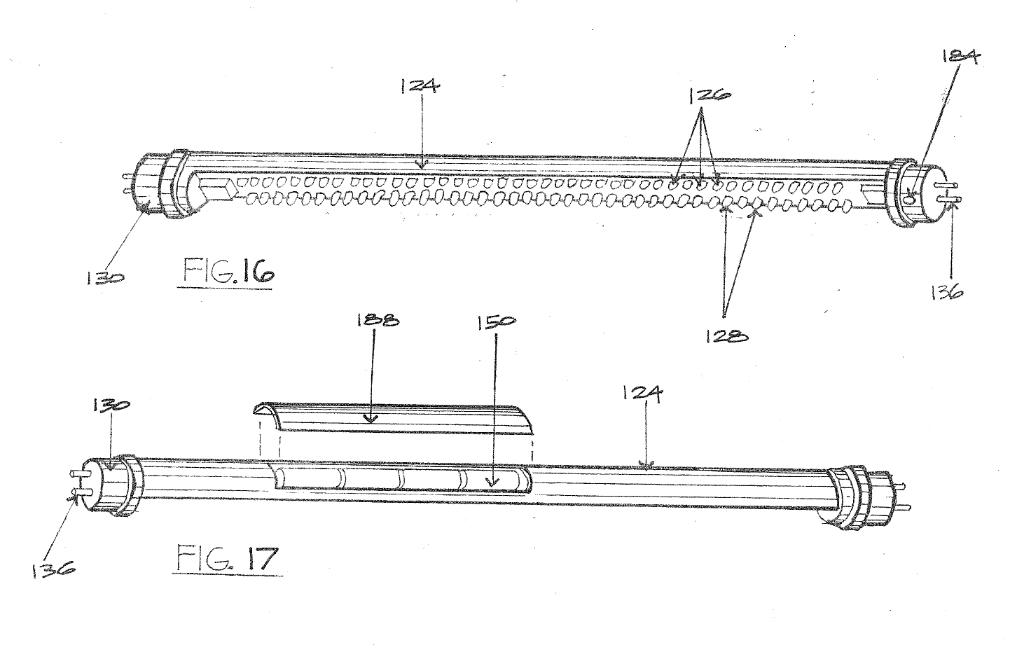

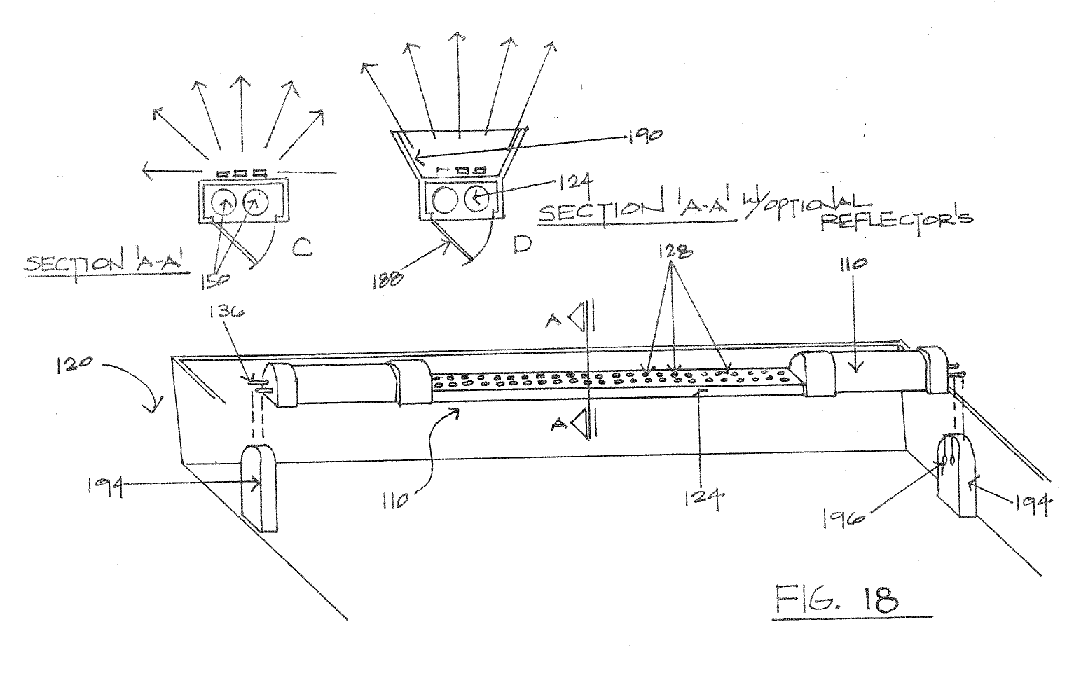

FIG. 1 is an illustration of a perspective view of a first embodiment of an emergency or backup lighting assembly 10 employing one or more light emitting diodes (LEDs). A housing or elongated tube 11 contains all internal circuitry and lighting as described below and may be manufactured as known in the art. In general, the tube 11 may be substantially similar to the housing or tube typically employed for a fluorescent light bulb, for example.

As shown in FIG. 1, an array or subassembly 12 of one or more light emitting diodes is contained within the housing 11 and may be substantially coextensive with the housing 11. The array 12 may be formed as known in the art. At least one power supply connector 13 is provided at a first end 13a for charging the batteries as explained below. In the embodiment shown in FIG. 1, a first and a second connector 13 are provided at a first end 13a and a second end 13b, respectively. A photocell switch 14 operably communicates with the LED circuitry to provide direct current (DC) or power thereto, and actuates and deactivates the LED circuitry when light is absent or present, respectively.

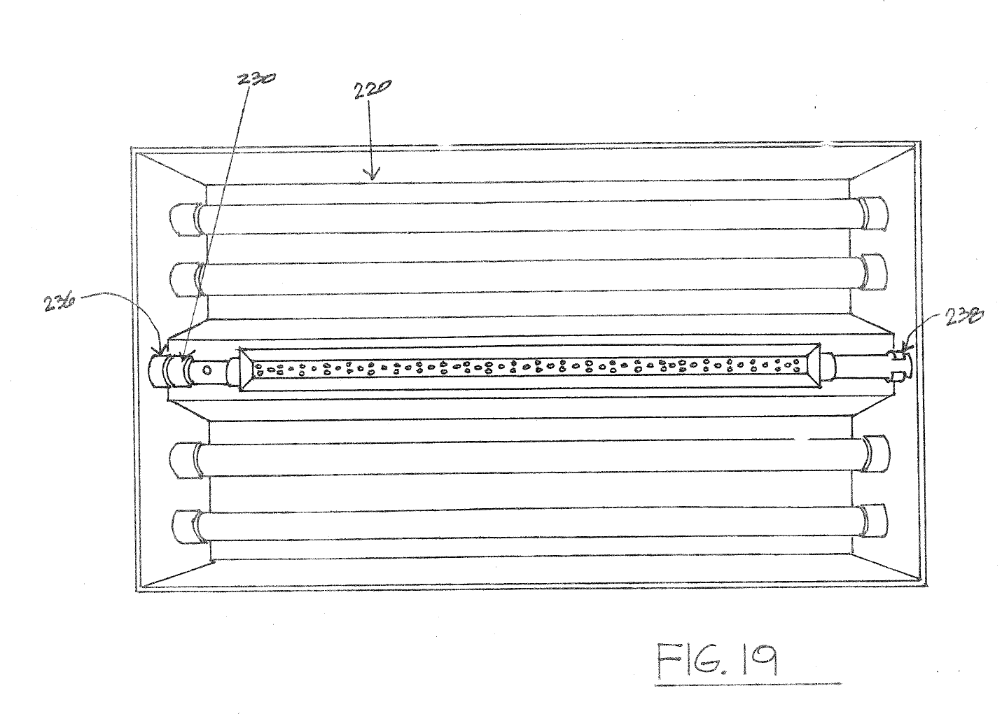

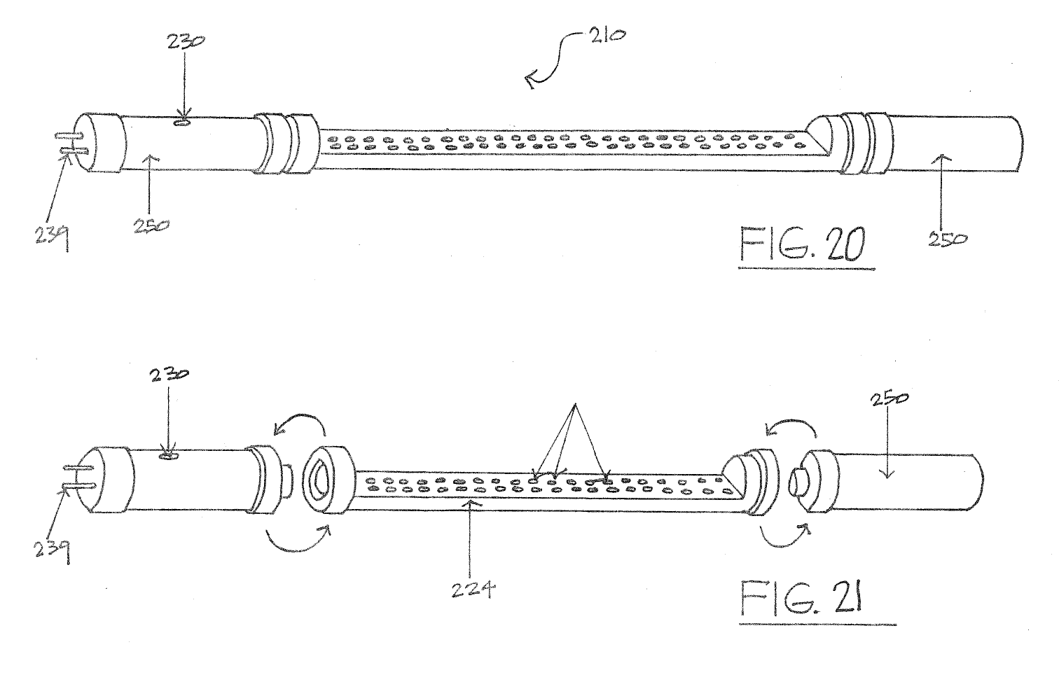

As shown in FIG. 2, a panel 15 is removably fixed to housing 11 and covers an inner cavity or recess 15b. One or more batteries 16, preferably lithium rechargeable batteries, may be stored within recess 15b and provide DC power to the LED array 12 upon switching of photocell switch 14. A test circuit 18 may be provided on the outer housing 11 to provide convenient testing of the emergency lighting circuitry.

In one embodiment shown in FIG. 3, a conventional fluorescent light assembly 19 is provided in accordance with the present invention. A troffer or housing 20 contains one or more fluorescent tubes 21, all AC (alternating current) powered in a conventional manner. Other solid state lighting assemblies/units 21 are contemplated in accordance with the present invention, and may include other solid state lighting units such as incandescent, LED, mercury-based, and other types of solid state lighting units. As also indicated or alluded to in FIG. 3, a ballast (not shown) may also be provided to control the electric current applied to the fluorescent tubes 21. A ballast cover 22 may be provided down the center of the solid state lighting unit 21 thereby hiding the ballast area from view. FIG. 3 also illustrates an elongated LED night light assembly 10, retained outside of the ballast cover 22. One or more sockets 39 receive one or more corresponding connectors 13 at ends 13a and 13b of light assembly 10, thereby providing alternating current power to the night light assembly 10 to at least one of the connectors 13. Alternating current may be directly provided by a continuous circuit from service/power box 26 to socket(s) 39 vis a vis line 25, for example. The fluorescent bulb(s) 21 function as the primary light, and are operated by a remote switch 24. A photocell switch 23 operatively communicates with light assembly 10 to activate and deactivate the light assembly 10 by turning the bulb(s) 21 off and on, respectively. Accordingly, as the bulbs 21 are turned off at the end of the day, the photocell 23 will recognize the waning light and activate the light assembly 10. On the other hand, when the lights 21 are turned on, the photocell 24 will recognize the increasing light and deactivate the light assembly 10.

FIG. 7 exemplifies one end 40 of the troffer or housing 20 of FIG. 3. Sockets 42 are configured to receive conventional solid state lighting units such as fluorescent or LED tubes, while socket 39 is configured to receive a night or emergency light unit 10 in accordance with the present invention. A three-wire system is illustrated in FIG. 7 and eliminates the need for a toggle switch or other switch as the actuation and de-actuation means for the fluorescent or other solid state lighting source and the second light source (night light). Referring to FIGS. 3, 7, and 10, the LED array 78 powered by sockets 39 is activated by electronic communication with a standard AC power supply 44 (e.g. 110 VAC). As photocell 43 detects a darkened condition, alternating current in normal circumstances is then only applied to socket 39, and not to sockets 42. As shown in FIGS. 3-6, for example, the periphery of the housings 30 is generally depicted as being circumferential. It will be appreciated that the peripheral geometry of the housing 30 may be formed to accommodate the spatial requirements of the circuitry 35, and may therefore for example only, take on a “half-rectangular” cross-section to fit in the requisite components. Nevertheless, the circumferential geometry of the housing 30 is preferably maintained at least around the ends 13a and 13b to facilitate a ready receipt of the connectors 34 within the female sockets.

Various other optional features such as dimmer switches or multi-colored LEDs may be provided.

As shown in yet another embodiment in FIGS. 4, 5, and 6, a circuit board 35 is contained within night light housing 30 and provides circuitry to convert an incoming 110 VAC to 12 -15 VDC. A photocell 38 is provided at one end of the housing 30, and as explained below relative to FIG. 10, operably communicates with the LED array 29 to provide DC power in the absence of light from the primary light source (not shown in these figures). Batteries 32 are contained within housing 30 and operably communicate with circuitry 31 and 35 (as explained relative to FIG. 10) in the event of a power interruption. A test control 33 is coupled to the LED array 29 and is useful for service tests to comply with regulatory requirements on periodic testing of emergency service equipment.

An AC/DC power supply/converter 70 is schematically shown in FIG. 10 and is provided to supply direct current power to the plurality of light emitting diodes or LED array 29. Converter 70 may, but not by way of limitation, be provided by V-Infinity of Oregon as identified as part number FSC-S15-15U, for example. It will be appreciated that other sources of alternating current may also be rectified or converted to appropriate amounts of direct current depending on design criteria. For example, 220 VAC could also be rectified to 15 VDC if desired.

As also schematically shown in FIG. 10, converter 70 therefore operably and electronically communicates with battery source charger 72 and to a photocell 74, thereby providing direct current power to each. Alternatively, a rectifier may instead be provided rather than the converter 70, so long as direct current power ultimately is provided in appropriate and operable amounts to the charger 72 and the LED array 78. Charger 72 electronically or operably communicates with one or more batteries 76 to maintain a charge to the rechargeable batteries 76. In the event of power failure, direct current by and through photocell 76 is interrupted due to the absence of alternating current being supplied to direct current power supply 70. Accordingly, in the event of power failure, direct current is provided from the batteries 76 to LED array 78.

Batteries 76 may be formed from nickel-metal hydrides, or from lithium ion technology. The batteries 76 may be provided from Sanyo Corporation of Japan, for example. The battery charger 72 may be, for example only and not by way of limitation, be provided from various designs available from Texas Instruments, part number bq24702, for example. The charger 72 may provide a “fast” charge for batteries depleted from a prolonged use. Or, the charger 72 may provide a “trickle” or “top off” charge to maintain the charge at a substantial maximum without overcharging. Accordingly, the charger 72 may also be designed to contain a “detector” mode whereby the charger 72 can identify whether a “fast charge” or “trickle charge” is necessary based on battery charge measurements. The LED array 78 may be provided from companies such as Stand Electronic Co., Limited located in Guangdong, China.

As also schematically exemplified in FIG. 10, the photocell 74 may for example, but not by way of limitation, be provided from Advanced Photonix, Inc. as part number PDV-P8101,and is operable based on a darkened condition, either from deactivation of the primary lighting assembly and bulbs 21, or, by the onset of a power outage with resultant darkness. LED light array 29 or 78 is thereby activated based on an absence of light from the primary light assembly and bulbs 21.

In yet another embodiment shown in FIGS. 8 and 9, batteries 51 may be provided at opposite ends of the light unit 53 thereby providing emergency or night lighting to the LED array 52. Contacts 55 may be seated within female receptacles within a light assembly such as shown in FIG. 3. As shown in FIG. 9, the batteries 51 may be placed within storage compartments 54. The compartments 54 may then be rotatably fixed in electronic contact with each end of the LED array 53, thereby providing a direct current power supply in the event of an absence of power from the alternating current supply. Although not shown, it will be appreciated that equivalent circuitry as described by FIG. 10 and as shown in FIGS. 5 and 6 as circuit board 35 are provided in light unit 53 thereby converting or rectifying alternating current to direct current in the same way as described relative to FIG. 10.

Further, the battery source may contain consumable rather than rechargeable batteries. As a result, the charger 72 would not be necessary. The “consumable” battery source would then be actuated based on a default switch from the photocell 74 for example, indicating that direct current supplied from the power supply 70 had been interrupted, whereby the LED array 78 is actuated based on normal or consumable battery power.

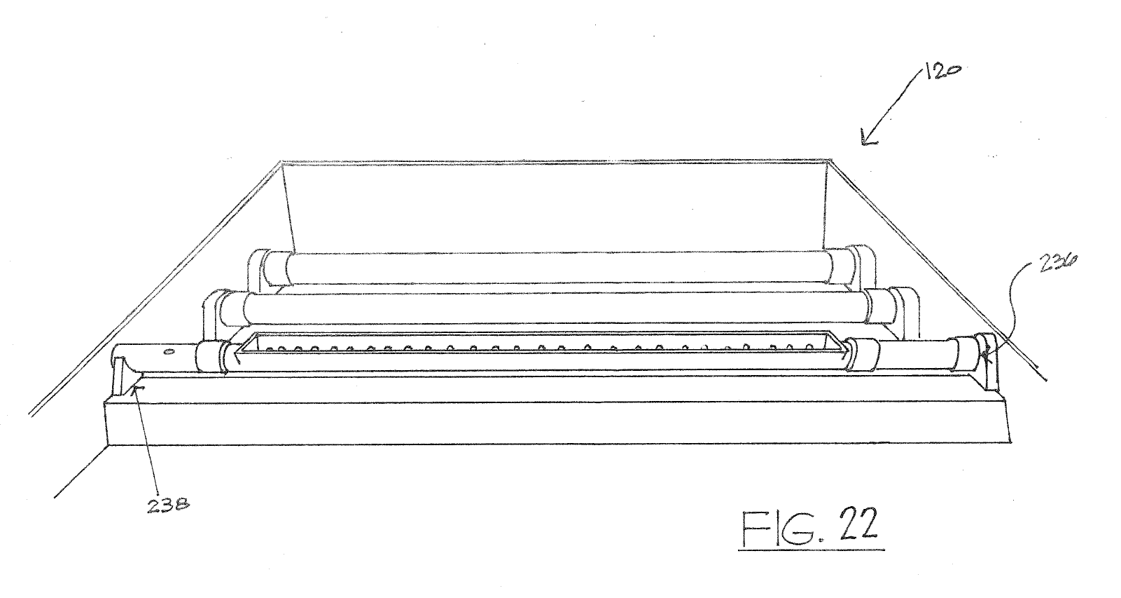

In yet another aspect of the invention illustrated in FIGS. 11-27, and as particularly shown in FIG. 23, a housing or troffer 120 may be employed to contain one or more tubeless and bulb-free lighting units 122. As shown in FIG. 11, a sub-housing 124 is formed as a tubeless and bulb-free sub-housing, in contrast to and as distinguished by the tubular bulbs typically used in fluorescent tube technology, for example. The term “bulb-free” as used herein is meant to convey that the sub-housing 124 is not encased with glass or otherwise formed as a bulb or a portion of a bulb. The term “bulb-free” is not meant to convey that no bulbs are used within the sub-housing 124, light emitting diodes for example, but that the elongated housing is itself not a bulb or a bulb portion. As shown in FIG. 11, the sub-housing 124 may be elongated and co-extensive with the length of a conventional fluorescent tube for example, but does not share the geometric design of the fluorescent tube/bulb. It will be appreciated that other embodiments as disclosed in FIGS. 1-9, for example, may be presented in tubular housings or bulbs. Nevertheless, because of a heat management advantage, the embodiments exemplified in FIGS. 11-26 contain one or more open bulb-free sub-housings, thereby permitting the steady-state release of heat from the sub-housing, and thereby prolonging the life of the LEDs contained within the sub-housing 124.

Referring to FIGS. 11 and 12, one embodiment of a tubeless and bulb-free sub-housing 124 is illustrated. A first array of one or more light emitting diodes (LEDs) 126 may be contained within sub-housing 124 and is selectively operated upon receipt of a signal occurring in the absence of ambient light, thereby operating as an emergency/night light. A second array of one or more light emitting diodes 128 may be contained within sub-housing 124 and is operated upon receipt of a DC signal converted from an AC power supply as a solid state lighting source. One of the two end caps 130 are positioned at one of the two ends 132 or 134 of the light unit 110. Prongs 136 are integral to each end cap 130 and facilitate electrical communication with a mating female socket within a light housing 120 (as shown in FIG. 23, for example). The elongated nature of the sub-housing 124, in one embodiment perhaps coextensive with a conventional fluorescent tube, makes the present light unit 110 a suitable and fit replacement insert for a conventional fluorescent tube assembly within a conventional troffer. Battery compartments 140 may be positioned on one or more ends of the light unit 110 for placement of a battery source therein.

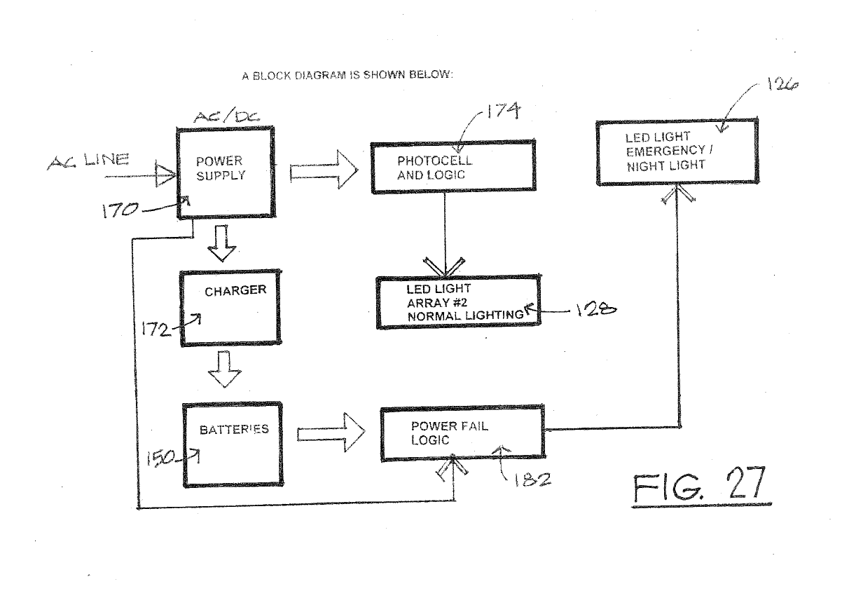

As shown in yet another embodiment in FIGS. 13, 14, and 15, a circuit board 135 is contained within sub-housing 124 and provides circuitry (a rectifier for example) to convert an incoming 110 VAC to 12-15 VDC. A photocell 138 may be provided within the sub-housing 124, and as explained below relative to FIG. 27, operably communicates with the first LED array 126 to provide DC power in the absence of ambient light, and if desired, from the absence of the primary light source provided by LED array 128. As shown in FIG. 27, an AC power sensor 140 may be connected to an output of the AC/DC power supply and to an output of the battery source 150. In the event of a loss of AC power, the AC power sensor 140 senses the loss of energy and switches the light unit 110 to DC power from the batteries. The DC power from the batteries is thereby routed to the photocell 138 and therefore provides power to the first LED array 126 in the absence of ambient light, during an emergency situation for example.

A test control 133 may be coupled to the first LED array 126 and is useful for service tests to comply with regulatory requirements on periodic testing of emergency service equipment. As shown in FIGS. 14 and 15, batteries 150 may be housed within sub-housing 124 in a linear fashion, and adjacent LED arrays 126 and 128.

An AC/DC power supply/converter 170 is schematically shown in FIG. 27 and is provided to supply direct current power to the first LED array 126. Converter 170 may, but not by way of limitation, be provided by V-Infinity of Oregon as identified as part number FSC-S15-15U, for example. It will be appreciated that other sources of alternating current may also be rectified or converted to appropriate amounts of direct current depending on design criteria. For example, 220 VAC could also be rectified to 15 VDC if desired.

As also schematically shown in FIG. 27, converter 170 may operably and electronically communicate with battery source charger 172 and to a photocell 174, thereby providing direct current power to each. Alternatively, a rectifier may instead be provided rather than the converter 170, so long as direct current power ultimately is provided in appropriate and operable amounts to the charger 172 and the LED arrays 126 and 128. Charger 172 may electronically or operably communicate with one or more batteries 150 to maintain a charge to the rechargeable batteries 150. In the event of power failure, direct current by and through photocell 174 is interrupted due to the absence of alternating current being supplied to direct current power supply 170. Accordingly, in the event of power failure, direct current is provided from the batteries 150 to first LED array 126. As shown in FIG. 27, a power sensor 182 normally communicates with a signal from the power supply 170, thereby confirming the existence of AC power. In the event of an interruption in the power supply 170, the power sensor 182 switches to battery power from the battery source 150, thereby providing DC power in an emergency situation. The battery current is directed to the photocell 174 and provides power to first LED array 126 thereby providing emergency lighting in the absence of ambient light. As with the embodiments of FIGS. 1-10, the batteries may be disposable thereby obviating the need for a battery charger within the circuitry.

Referring to FIGS. 11 through 15, batteries 150 may also be provided at opposite ends of the light unit 110 thereby providing emergency lighting to the LED array 126 in the event of a power outage. Contacts 155 may be seated within female receptacles within a light assembly such as shown in FIG. 23. As shown in FIG. 12, the batteries 150 may be placed within storage compartments 154. The compartments 154 may then be rotatably or otherwise fixed in electronic contact with each end of the LED array 126, thereby providing a direct current power supply in the event of an absence of power from the alternating current supply. Although not shown, it will be appreciated that equivalent circuitry as described by FIG. 10 and as shown in FIGS. 5 and 6 as circuit board 35 are provided in light unit 110 thereby converting or rectifying alternating current to direct current in the same way as described relative to FIG. 10.

Referring to FIG. 16, a sub-housing 124 may be shaped as a bulb-free and partial tube, so that the LED array 128, operable during normal operating conditions, is exposed to the ambient and open environment of the housing 120, thereby presenting a heat management advantage. The embodiment shown in FIG. 16 may contain end caps and prongs as shown in FIGS. 11 and 12, thereby providing a ready replacement for conventional fluorescent tubes for example. The LED array 128 may communicate with an AC/DC power supply 170 (not shown), and may operate with or without the additional night light first LED array 126. The circuitry may contain a rectifier 170 for converting AC power to DC power and omit any batteries for emergency use. Additionally, if desired, an LED array 126 may still be used to supply night lighting and as described relative to FIGS. 11 and 12, whereby the array 126 is illuminated as photo-sensor 184 is actuated upon the absence of light. As stated above, the LED array 126 is selectively illuminated by the photo-sensor 184 in lieu of the LED array 128, which operates during normal operating conditions during the day. In this embodiment, the circuitry may be provided as known in the art. U.S. Pat. No. 7,049,761, herein incorporated by reference in its entirety, exemplifies certain circuitry that may be useful in the present invention.

Referring to FIG. 17, the backside of the embodiment illustrated in FIGS. 13-15 is shown whereby a door panel 188 provides an access to replace batteries 150 as needed.

Yet another embodiment of FIG. 18 illustrates how a lighting unit 110 of FIGS. 1 and 2 can be inserted within a troffer or housing 120. Cross-sections are also shown taken along the line A′-A′. In a first cross-section C, the illumination of the LEDs is unconstrained and radiates in an arc approximating 180 degrees. In a second cross-section D, optional adjustable reflectors 190 are fixed or positioned on the sub-housing 124 to form a desired angular relationship from the sides 192 of the sub-housing 124 of the cross-section D, thereby directing more lighting to areas below the lighting unit 110. As shown in FIG. 18, in one embodiment, the sub-housing 124 is slidably engaged within female mounts 194 as prongs 136 interface and electrically communicate with electrical contacts 196 within the mounts 194.

Yet another embodiment of FIGS. 19-22 illustrates a one-endcap embodiment of the present invention. An end cap 230 is fixed at one end of the sub-housing 224. A set of prongs 239 is fixed within the end cap 230 and electrically communicates with a female socket 236 for receipt of AC energy within the lighting unit 210. As shown in the drawings, the embodiment is substantially similar to the embodiments of FIGS. 1 and 2 with the exception that the batteries 250 on each end of the sub-housing 224 are powered or charged by electrical communication from only one endcap 230. The electrical circuit loops through the LED arrays 226 and 228 to provide the same functional relationship, night light/emergency lighting and conventional lighting, respectively, as in the embodiment of FIGS. 11 and 12. U.S. Pat. No. 6,936,968, herein incorporated by reference in its entirety, exemplifies but does not limit the various circuitries that could be employed to accommodate the one-endcap system. As shown in the FIGURES, the sub-housing is supported by the socket 236 and a mounting bracket 238 at an opposite end of the sub-housing having no end cap 230, for support of the end having no end cap.

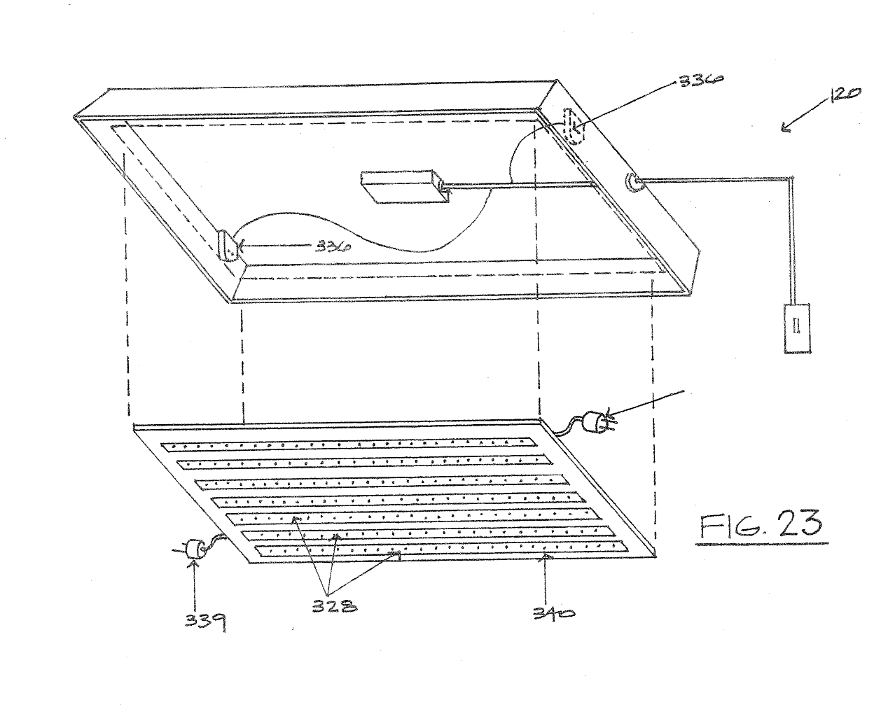

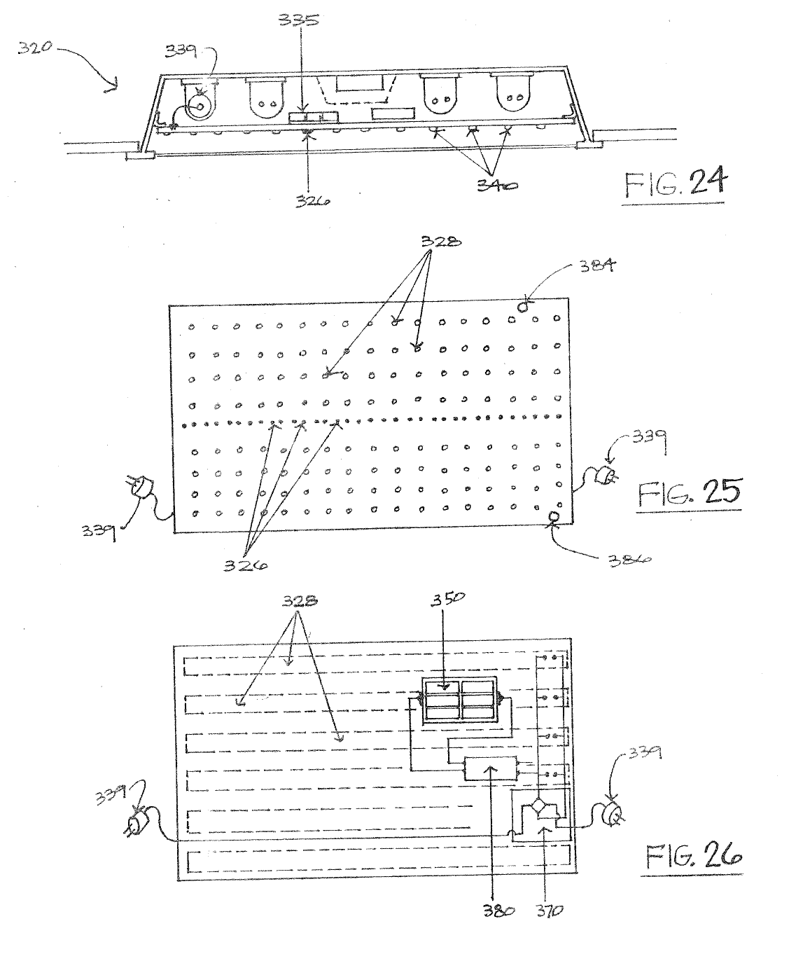

FIGS. 23-26 illustrate an embodiment that provides a modular concept of the present invention. As shown in FIG. 23, a plurality of LED arrays/strips 328 are fixed to a panel or sub-housing 340 and electronically communicate with two female sockets 336 by seating two conductive plugs or two sets of prongs 339 electrically communicating with the set of LED arrays 328. As shown in FIG. 24, the panel 340 is seated within the troffer 320 and may be used to replace and retrofit current fluorescent tube troffers now in service. As shown in FIG. 25, a plurality of LED arrays 328 is used to provide conventional lighting during normal hours of operation. At least one first LED array/strip 326 is used to provide night lighting and if desired, emergency lighting, in accordance with the present invention. As shown in FIG. 26, the plurality of LED arrays 328 and the first LED array 326 are wired on the backside of the panel 340 in accordance with the block diagram presented in FIG. 27. The circuitry shown in FIG. 26 contains a battery source 350, a rectifier/converter 370, a battery charger 380 if desired, a photo-sensor 384, and an AC sensor 386, wired and configured as shown in FIG. 27. As with other embodiments, the battery charger 380 may be omitted from the circuitry if disposable batteries are used.

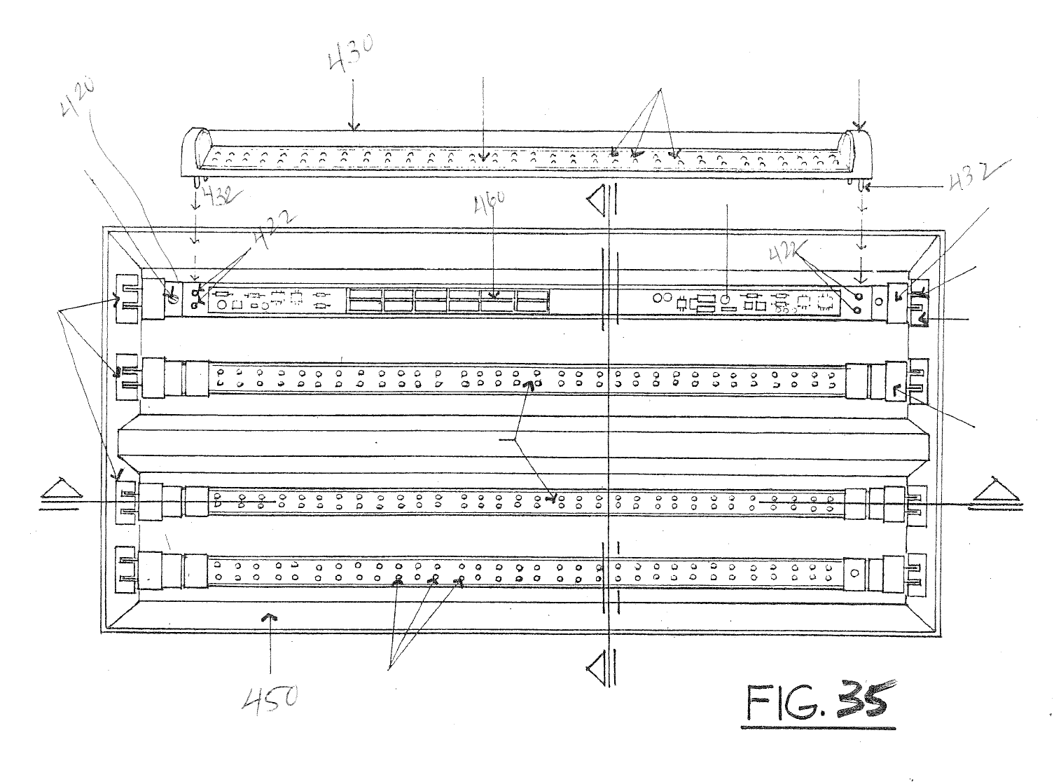

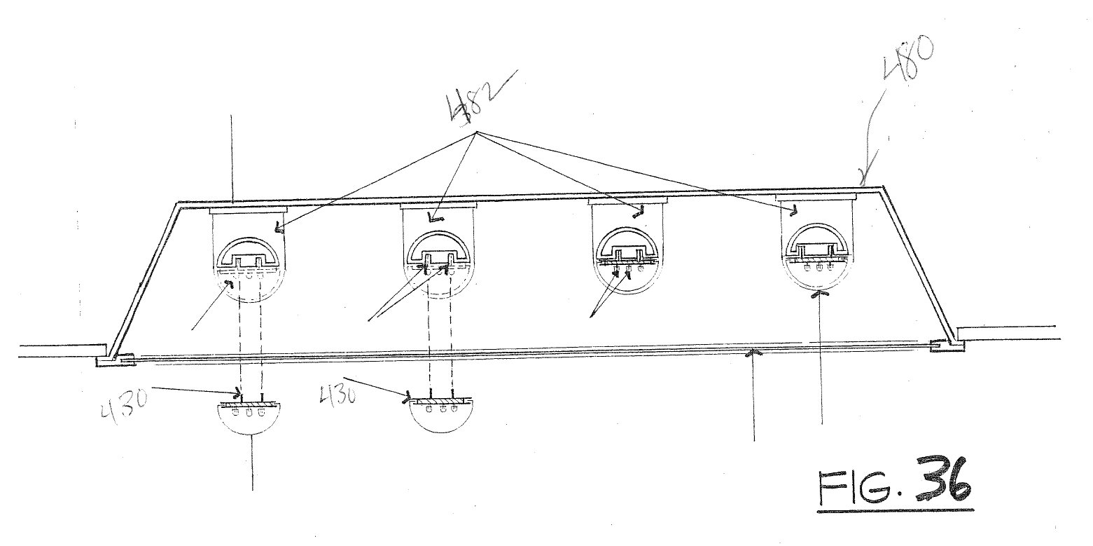

In yet another aspect of the invention, FIG. 28 exemplifies yet another replacement light assembly 410 for a fluorescent tube troffer, the assembly containing an AC-DC converter (schematically represented, but not specifically shown) and other desired circuitry (schematically represented but not specifically shown) within a housing insert 420 for a troffer, and further containing a modular LED insert 430 for insertion within the housing insert 420. The modular LED insert 430 may be fitted with at least one pair of conductive plugs or prongs 432 preferably at one or more ends 434 and 436. In general, the LED insert module 430 contains one or more light emitting diodes 433. One or more pairs of complementary female sockets 422 within the housing insert 420, are preferably formed at one or both ends 424, 426 of the housing insert 420. When assembled, each respective pair of conductive plugs or prongs 432 are slidably, pressed-fit, or otherwise conductively engaged with a respective pair of female sockets 422. Once the modular LED insert or module is seated within the housing insert as shown in FIGS. 30, 33, 34b, 34c, 34e, 34f, 34h, 34i, 36, 38, 39a, 39b, and 39d, the resultant light assembly by virtue of the troffer prongs 440 on at least one end 424/426 of the housing insert 420, may be inserted within a known troffer light fixture 450 or 480 for fluorescent light tubes as shown in FIGS. 35 and 37.

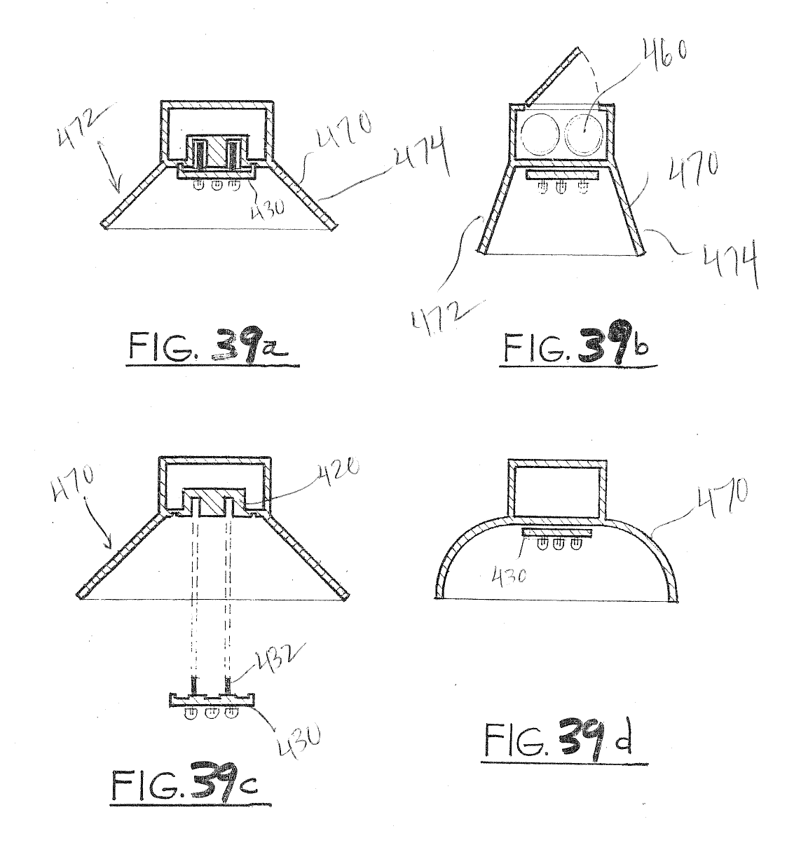

As shown in FIGS. 40 and 41, the LED module 430 may be slidably engaged to housing insert 420. As shown in FIG. 40, the prongs 432 may horizontally engage the female sockets 422 thereby providing direct current voltage from the housing insert 420 which as explained below, in turn receives and converts alternating current voltage provided by the troffer or light fixture. A snap-fit or securing member 437 is provided on the LED module end 436 for removably securing the LED module 430 to the housing insert 420. As such, a corresponding aperture 427 is formed proximate the end 426 of the housing insert 420, for receipt of the securing member 437. In this way, the LED module 430 is removably seated or secured to the housing insert 420.

As with other embodiments of the present invention, and as shown in FIGS. 29, 33, 34c, 34f, 34i, and 35, a battery source 460 containing one or more batteries may be provided in modular lighting assemblies 410 to provide emergency power in the event of power loss. Furthermore, as with other embodiments, in the present modular LED light assemblies, photo resistors or light sensors may be employed to provide night lighting function in the absence of light. In accordance with this aspect of the invention, the housing insert 420 contains any desired circuitry including rectifier or converter circuitry, battery circuitry, and night light and emergency light circuitry as discussed with regard to other embodiments of the invention described in FIGS. 1-27. The LED insert 430 contains electrical prongs 432 that are made from conductive materials that are known in the art. These materials may include steel, copper, or other metallic conductors for example.

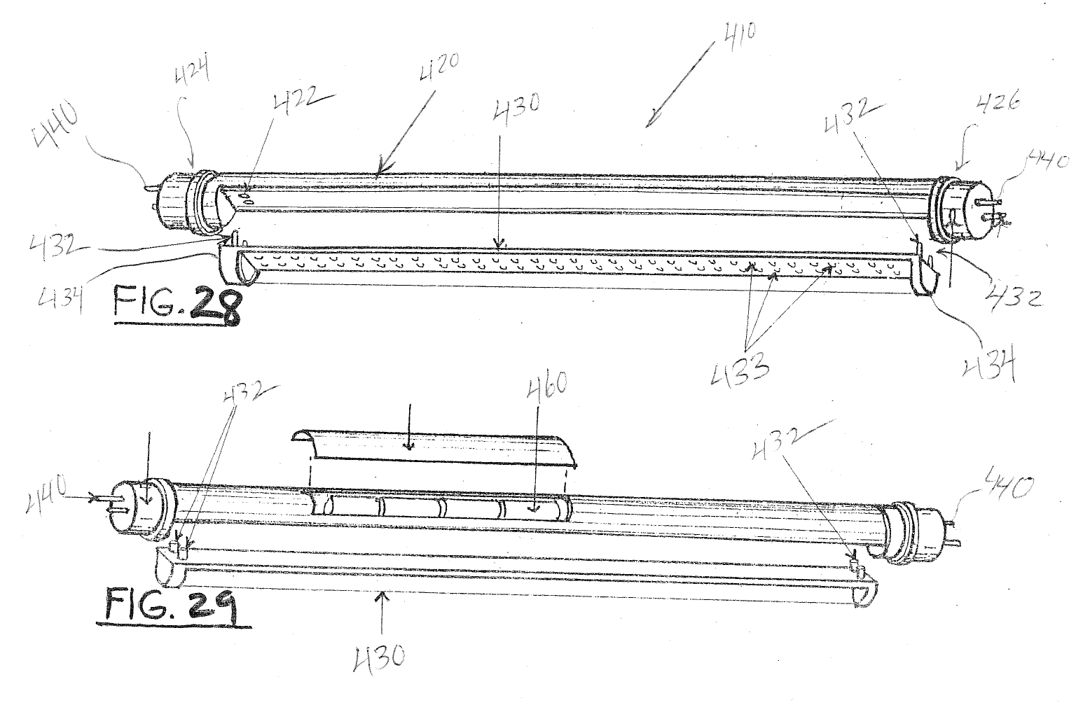

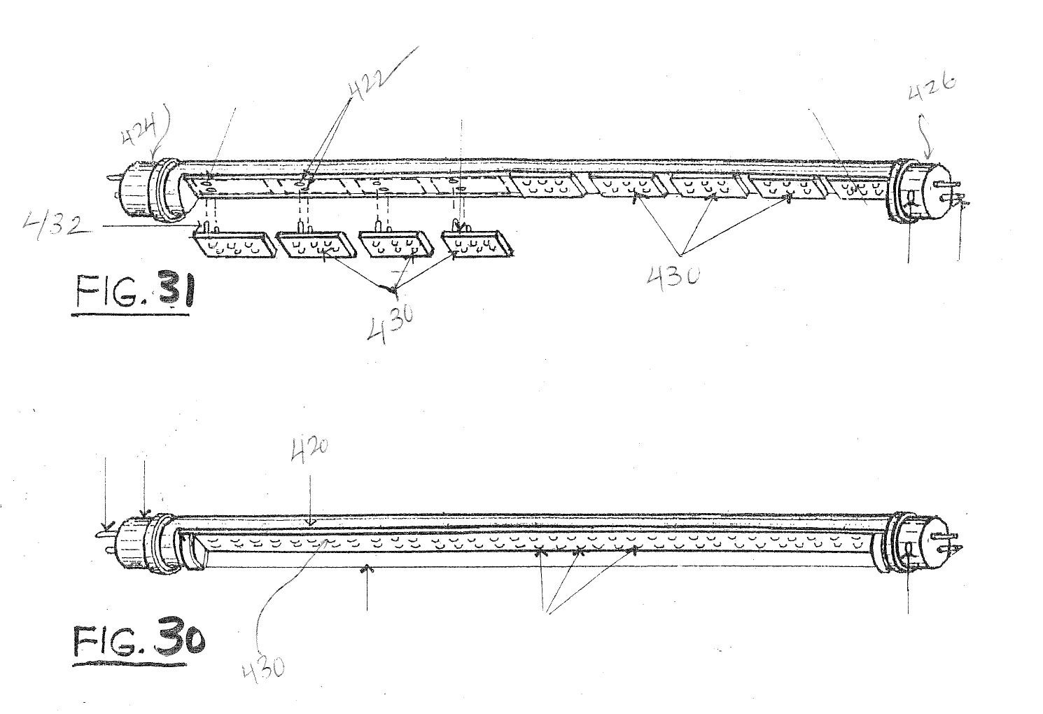

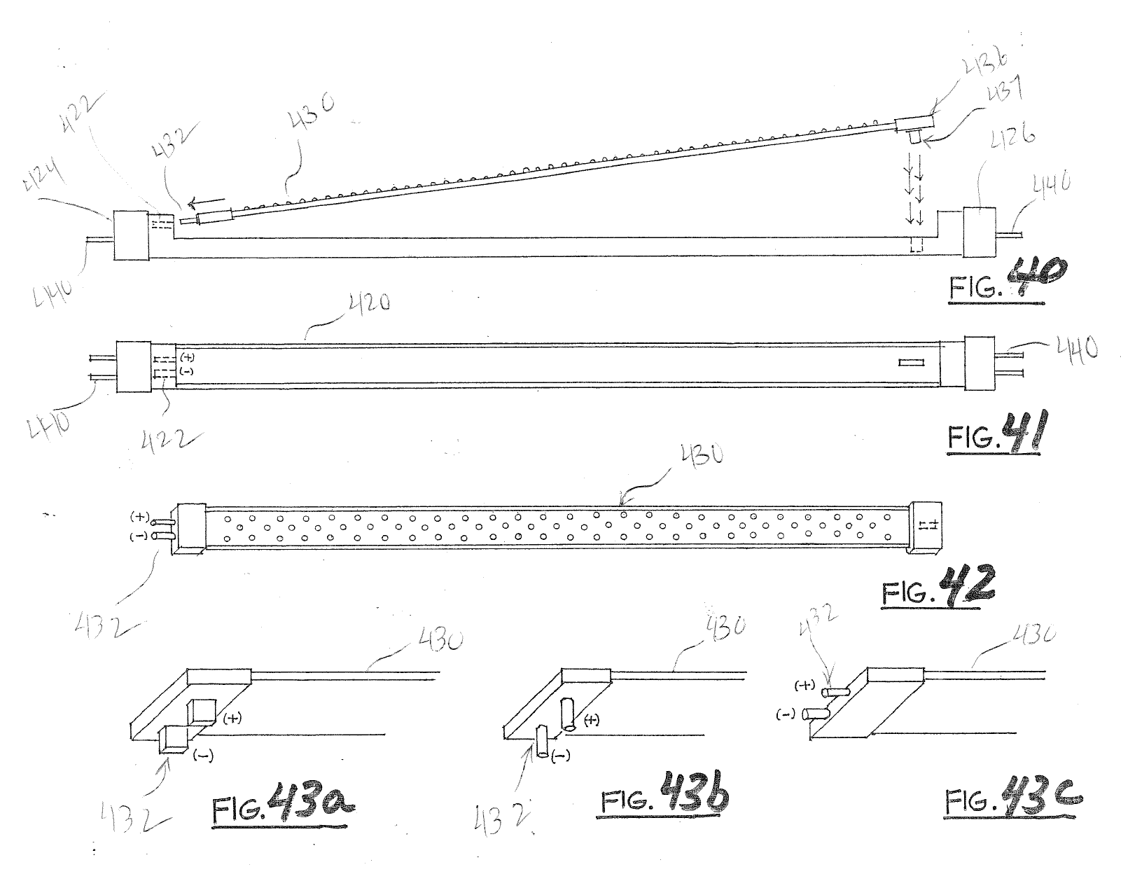

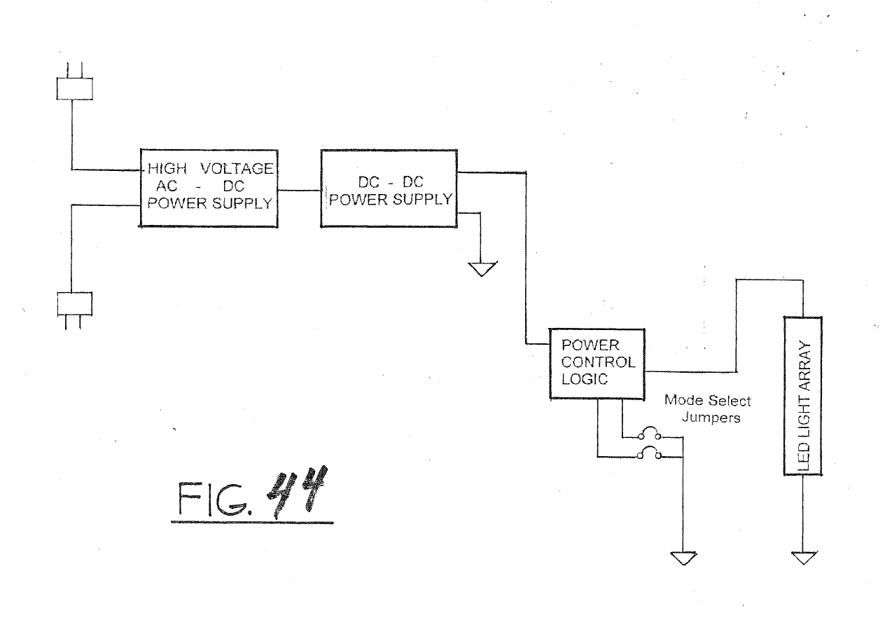

In keeping with the modular concept, and as exemplified in FIGS. 28 and 31 for example only, one or more modular LED light strips or sub-modules 430 may be employed in the housing insert 420 and modular lighting assemblies 410 of the present invention. In further keeping with the modular concept, it will be appreciated that modular lighting assemblies may be provided with LED arrays covered by bulbs, as shown in FIGS. 28, 29, 30, 32, 33, 34a through 34f, or, if desired, with one or more bulb-less modular LED light strips or modules such as those shown in FIGS. 31, 34g through 34i, 37, 38, 39a through 39d, 40, 41, 42, and 43a through 43c. The LED light strips and/or sub-modules 430 may be assembled in a known manner wherein the light emitting diodes 435 are electrically connected to each other, in series or parallel, for example, thereby conducting the electric potential provided by the prongs 432 when mated with the female sockets 422. As shown in FIG. 31, a plurality of sub-modules 430 may be provided with corresponding prongs 432 provided on each sub module 430. As also shown in FIG. 31, for each set of prongs 432 provided in each sub-module 430, a corresponding plug or female conductive receptacle 422 is formed in the housing insert 420 for receipt of the corresponding pair of prongs 432. Accordingly, a plurality of sub-modules 430 may be seated in a corresponding number of plugs 422, thereby providing electrical communication with an electrical conductor (not shown) running the length of the housing insert 420.

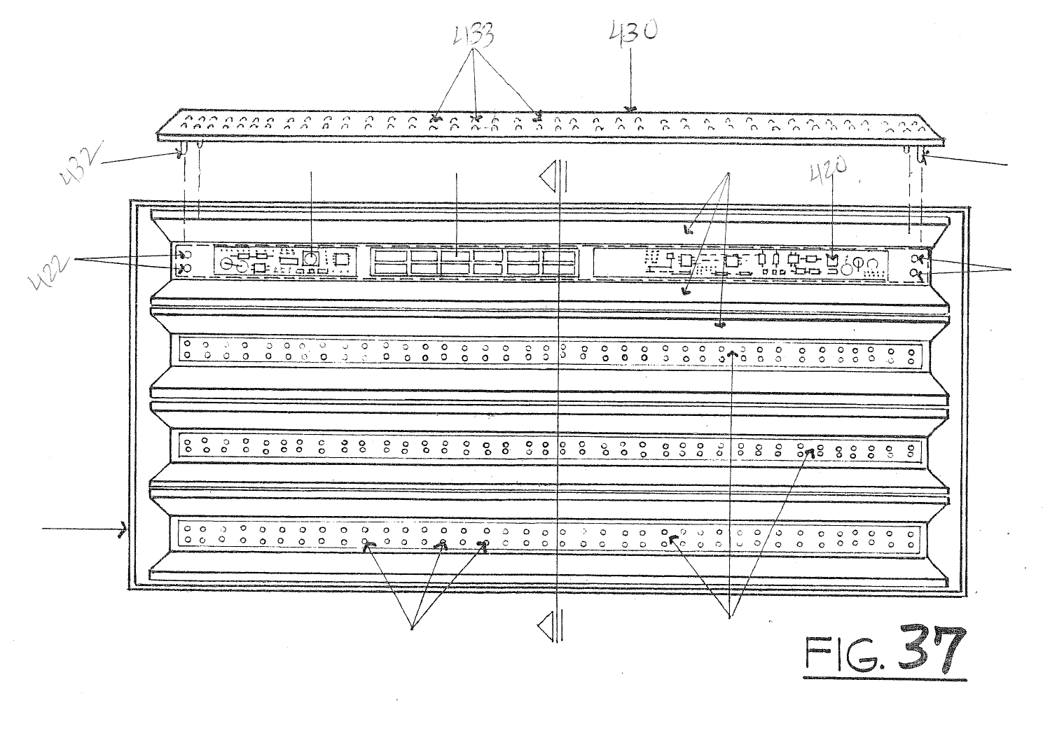

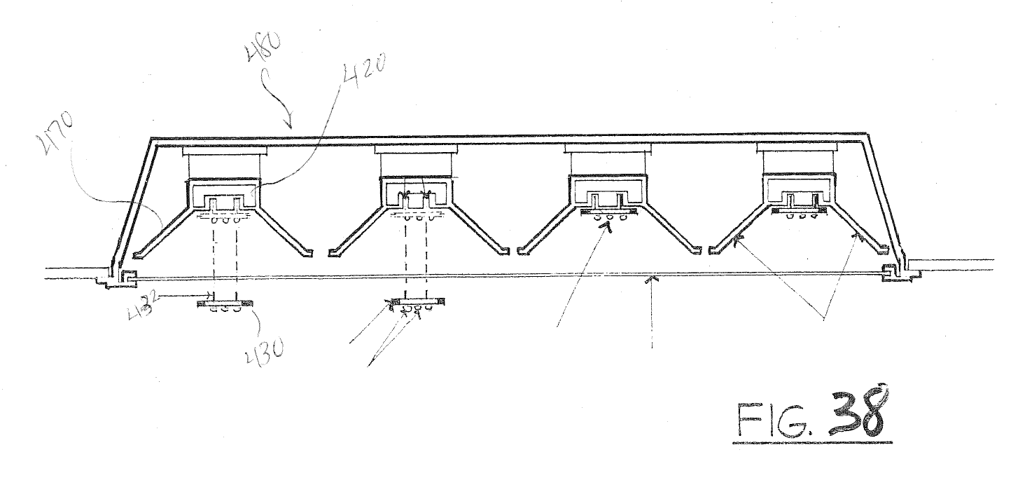

Yet another aspect of the invention includes the packaging advantage provided by designing the light assemblies in rectangular or other geometric cross-sections as shown in FIGS. 39a through 39d, for example. Further to the packaging advantage, and as shown in the FIGURES, the modular LED light strips 430 may be designed as semi-cylindrical bulbs or bulb-less flat strip geometry, for example.

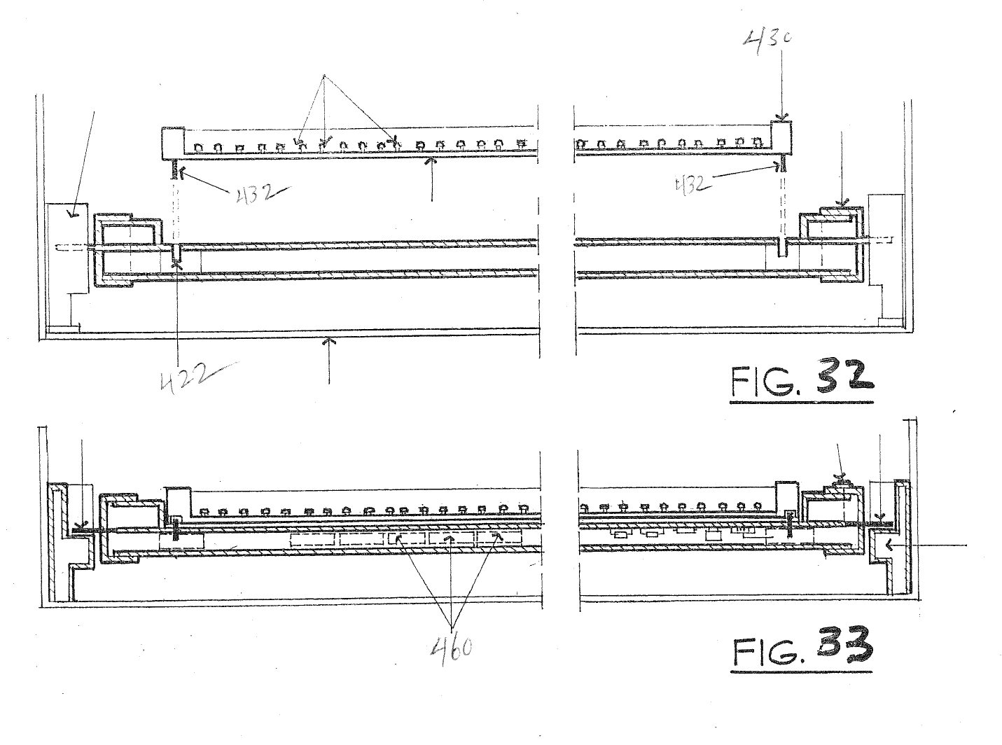

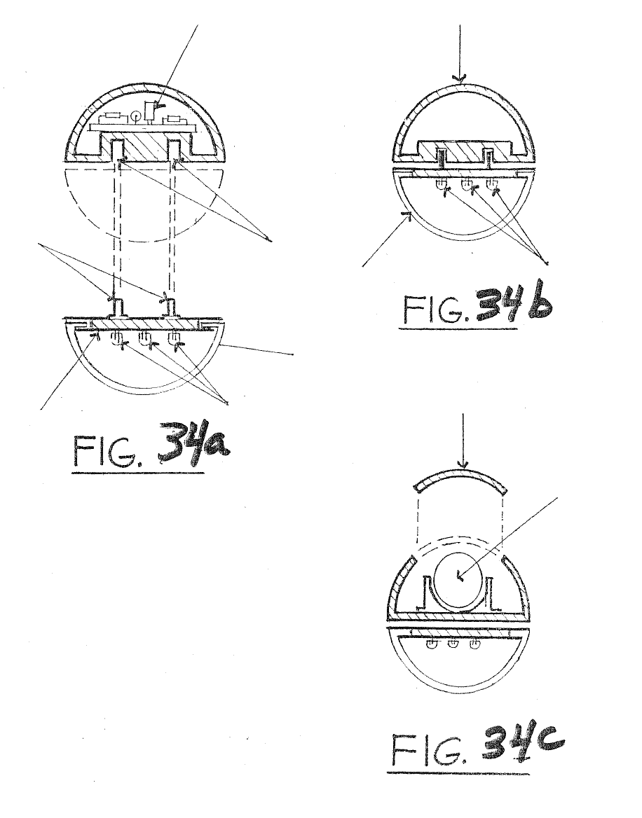

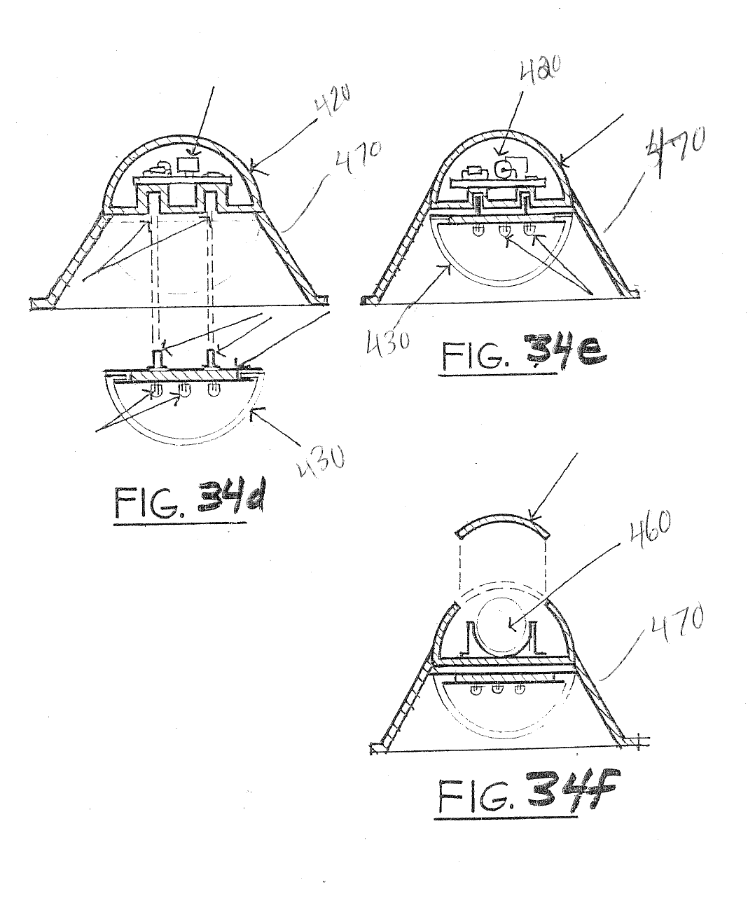

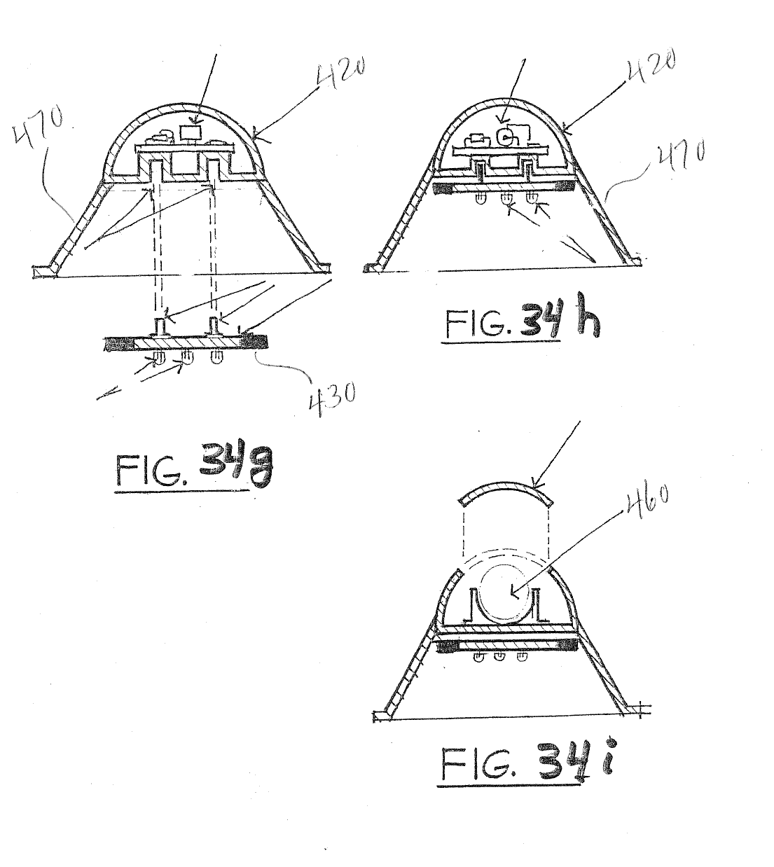

Yet another aspect of the invention includes the more efficient use of LED light as it is transmitted from the lighting assembly to the underlying area to be illuminated. Accordingly, a light deflector 470 attached to a lighting assembly 410 formed in accordance with any aspect of the present invention is provided. As shown in FIGS. 34d through 34i, 37, 38, and 39a through 39d, a light deflector 470 may be substantially coextensive with the length of the light assembly or modular light assembly 410, and may comprise a first deflector panel 472 and a second deflector panel 474.

It will be appreciated that by tailoring the angular displacement of the deflector panels of the deflector or shroud, the light may be focused more intensely to underlying areas as desired. As a result, more efficient use of the LED lighting is facilitated, thereby reducing the overall energy required to provide adequate lighting, as compared to state of the art LED tubes, for example.

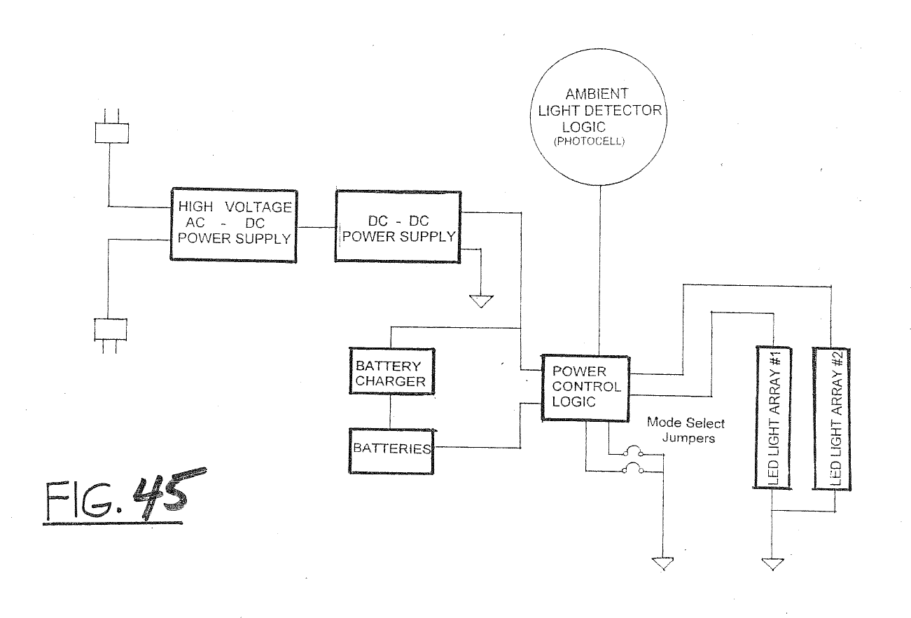

The modular LED light assemblies of FIGS. 28-40 may be electronically configured as shown in FIG. 44 or 45, for example. Alternatively, or in conjunction with the designs shown in FIGS. 1-40, power may be supplied to the light assemblies 410 as known in the art. For example, U.S. Pat. Nos. 7,815,338, 7,712,918, 7,510,299, and 7,049,761, incorporated herein by reference, exemplify various electronic configurations that may be employed in the contexts of the present invention.

In operation and in accordance with the present invention, alternating current power is provided to a troffer or light fixture 480. One or more light assemblies 410 are adapted to electronically communicate with at least one or more respective pairs of opposed sockets 482. One pair of light fixture sockets 482 correspond to each light assembly 410 that is installed within the troffer 480. A pair of housing insert prongs 440 are provided on each end 424 and 426 of the housing insert 420, whereby each pair of prongs 440 electronically communicates with a corresponding socket within a pair of opposed troffer sockets 482. The housing insert 420 contains all necessary rectifier and/or converter circuitry (described above with regard to FIGS. 1-10 for example) to convert the alternating current provided through prongs 440 into direct current, to be used by one or more LED arrays or insert modules 430. Other optional circuitry relative to this embodiment includes the night light and emergency light circuitry and battery sources described in other embodiments herein. This various circuitry is explicitly and/or schematically presented in FIGS. 1-40, and more particularly, with regard to this embodiment, in FIGS. 28-40. The LED insert module(s) are therefore powered by direct current entering through prongs or plugs 432 when connected to female plugs 422 within housing insert 420. Stated another way, LED insert module(s) are adapted to electronically communicate with the circuitry of housing insert 420 as prongs 432 are seated within female receptacles 422. It will be appreciated that the circuitry described with regard to the other embodiments of the specification, including those in FIGS. 1-10 illustrating night light and emergency light configurations may also be employed in the embodiments shown in FIGS. 28-40.

It will be understood that the foregoing descriptions of embodiments of the present invention are for illustrative purposes only and should not be construed as limiting the scope of the invention. As such, the various structural and operational features herein disclosed are susceptible to a number of modifications commensurate with the abilities of one of ordinary skill in the art, none of which departs from the various permutations described herein.

What is claimed is:

1. A light assembly comprising:
a housing insert adapted to electronically communicate with a power source to produce direct current voltage; and
a light emitting diode module adapted to electronically communicate with said housing insert, said light emitting diode module removably seated within said housing insert.

2. The light assembly of claim 1 further comprising:
a first female conductive receptacle formed proximate a first end of said housing insert, and a second female conductive receptacle formed proximate a second end of said housing insert; and
a first pair of conductive prongs formed proximate at a first end of said light emitting diode module and a second pair of conductive prongs formed proximate a second end of said light emitting diode module,
wherein said first and second pair of conductive prongs are each respectively seated within one of said first and second female conductive receptacles.

3. The light assembly of claim 1 further comprising a rectifier within said housing insert, said rectifier electronically communicating with said power source for converting alternating current to direct current voltage.

4. The light assembly of claim 1 further comprising a plurality of light emitting diode modules adapted to electronically communicate with said housing insert, said plurality of light emitting diode modules removably seated within said housing insert.

5. The light assembly of claim 1 further comprising a first deflector fixed to a first longitudinal edge of said housing insert, and, a second deflector fixed to a second longitudinal edge of said housing insert, thereby directing light produced from said light emitting diode module.

6. The light assembly of claim 1 wherein said light emitting diode module is a semi-cylindrical bulbs.

7. The light assembly of claim 1 wherein said light emitting diode module is a flat light emitting diode array.

8. The light assembly of claim 1 further comprising system circuitry configured within said housing insert, wherein said housing insert is configured to contain all system circuitry necessary to operate the removably seated light emitting diode module.

9. The light assembly of claim 1 further comprising:
a female conductive receptacle formed within said housing insert; and
a pair of conductive prongs formed in said light emitting diode module,
wherein said pair of conductive prongs is removably seated within one of said female conductive receptacle thereby removably seating said light emitting diode module within said housing insert, and providing electronic communication between said light emitting diode module and said housing insert.

10. A light fixture comprising:
a housing containing a pair of electronically conducting sockets for receipt of a light assembly;
a housing insert adapted to mate with said pair of electronically conducting sockets and to electronically communicate with a power source within said housing, said housing insert configured to provide power to one or more light emitting diodes; and
one or more light emitting diode modules each adapted to electronically communicate with said housing insert and each containing one or more light emitting diodes, said one or more light emitting diode modules each removably seated within said housing insert.

11. The light fixture of claim 10 further comprising:
a first female conductive receptacle formed proximate a first end of said housing insert, and a second female conductive receptacle formed proximate a second end of said housing insert; and
a first pair of conductive prongs formed proximate at a first end of said light emitting diode module and a second pair of conductive prongs formed proximate a second end of said light emitting diode module,
wherein said first and second pair of conductive prongs are each respectively seated within one of said first and second female conductive receptacles.

12. The light fixture of claim 10 further comprising a rectifier within said housing insert, said rectifier electronically communicating with said power source for converting alternating current to direct current voltage.

13. The light fixture of claim 10 further comprising a plurality of light emitting diode modules adapted to electronically communicate with said housing insert, said plurality of light emitting diode modules removably seated within said housing insert.

14. The light fixture of claim 10 further comprising:
a third pair of prongs on a first end of said housing insert, and, a fourth pair of prongs on a second end of said housing insert, said third and fourth pairs of prongs each respectively seated within one of said pair of electronically conducting sockets,
wherein alternating current is provided to said housing insert through said third and fourth pairs of prongs.

15. The light fixture of claim 14 further comprising a rectifier within said housing insert, whereby said alternating current is converted to direct current within said housing insert.

16. The light fixture of claim 10 further comprising system circuitry configured within said housing insert, wherein said system circuitry is sufficient to operate the removably seated light emitting diode module.

17. The light fixture of claim 10 further comprising:
a female conductive receptacle formed within said housing insert; and
a pair of conductive prongs formed in said light emitting diode module,
wherein said pair of conductive prongs is removably seated within one of said female conductive receptacle thereby removably seating said light emitting diode module within said housing insert, and providing electronic communication between said light emitting diode module and said housing insert.

18. A light fixture comprising:
a housing containing a pair of electronically conducting sockets for receipt of a light assembly;
a housing insert adapted to mate with said sockets and to electronically communicate with a power source within said housing, said housing insert configured to provide direct current power to one or more light emitting diodes; and
one or more light emitting diode modules adapted to electronically communicate with said housing insert, said light emitting diode modules removably seated within said housing insert.

19. The light fixture of claim 18 further comprising:
a battery source contained within said housing insert for powering said one or more light emitting diode modules in the event of power interruption.

20. The light fixture of claim 19 further comprising:
a battery charger contained within said housing and actuated by direct current power, said battery charger operably communicating with said battery source.
